(19) United States
(12) Patent Application Publication
(10) Pub. No.: US 2006/0112064 A1
(43) Pub. Date: May 25, 2006

(54) Computerized encounter notification system (CENS)

(76) Inventor: Brian Keith Ellerby, Raleigh, NC (US)

Correspondence Address: Brian Keith Ellerby, 9124 Riverview Park Dr., Raleigh, NC, 27613, US

(21) Appl. No.: 10/983,299

(22) Filed: Nov. 8, 2004

(51) Int. Cl. G06F 17/30

(52) U.S. Cl. 707/1

(57) ABSTRACT

CENS (Computerized Encounter Notification System) is an automated visitor tracking and notification system. Using existing technology in a new format, the system tracks and notifies an organization's staff of visitors and whom the visitor is there to see. CENS maintains a database of all visitors and their times of arrivals and departures. CENS using output devices to print a visitor's name, arrival time, the person who they are visiting and the time they signed out of the facility. CENS can be linked to existing data applications and systems to combine information; as decided by the user, to the visitor's information that prints off on the notification devices. In its simplest form, the CENS system consist of: (1) Hand recognition and input device (HRID) (2) Printing Output Device (POD) (3) Card scanner and printer (CSP) (4) Application and Database Server (ADS) All of the CENS components mentioned above are readily available on the open market. CENS is a new way of using existing software and hardware for tracking encounter information in a multitude of settings/environments. The system can be configured to send output from the HCID to the POD wirelessly or connections can be hardwired, depending on the desires of the end user. Organizations can use the CSP with duplexing capability to make copies of driver licenses, insurance cards and other patient identification media by simply asking the patient to insert their card into the CSP. The CSP will accept the media, copy, print and store it and eject the media back to its owner/visitor.

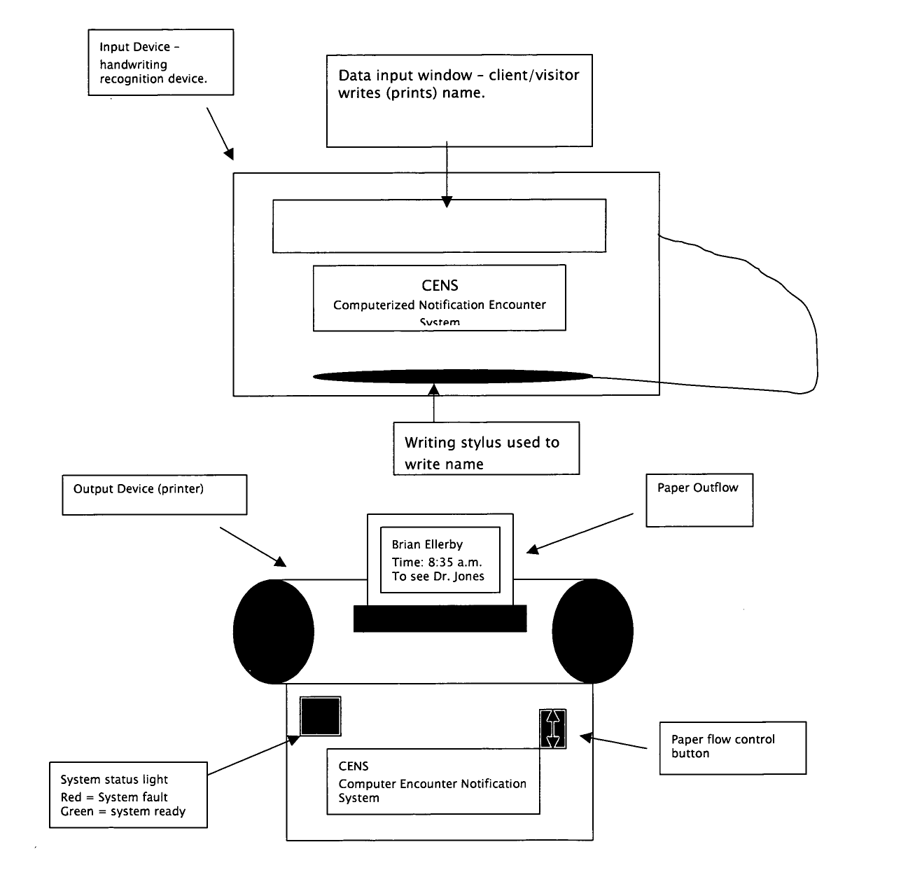

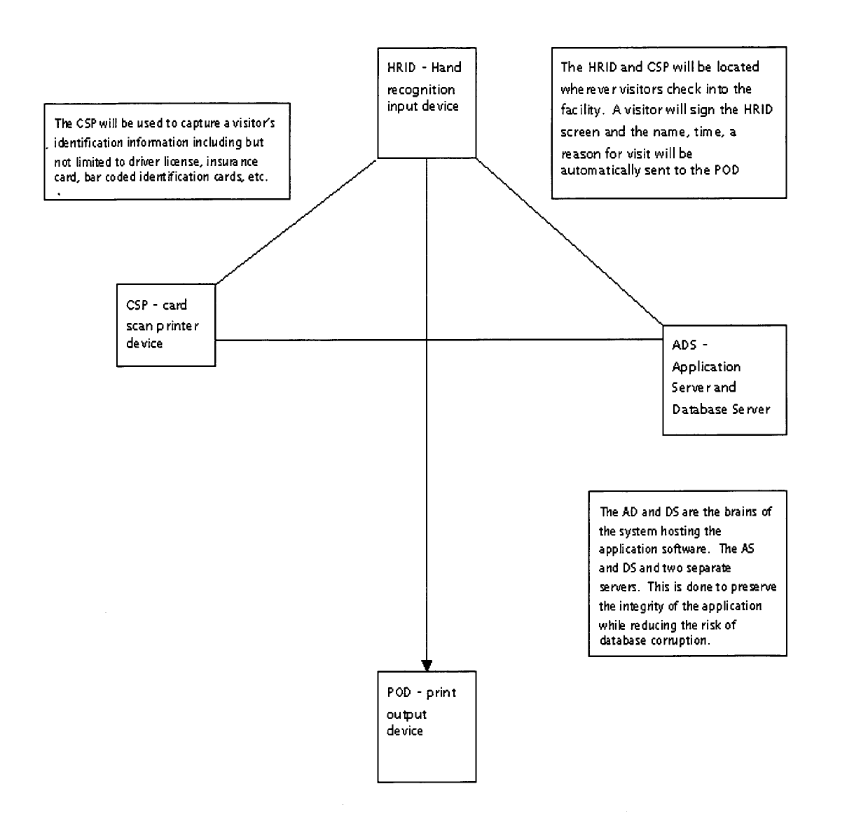

The system is totally HIPPA (Health Insurance Portability and Privacy Act) compliant allowing staff working in any environment requiring visitors to sign in to be quickly notified of the visitors arrival, arrival type, person whom they are there to see. The software can be modified to provide various information about the person signing the hand writing recognition device. This application uses existing hand writing recognition software and hardware technology to allow organizations to maintain a current electronic database of visitors to any facility requiring sign in by visitors. The devices include handwriting recognition devices; similar to the ones used at grocery stores and retail check outs to allow the visitor to write their name.

Upon replacing the writing tool/device (stylus) in its holding tray, the hand writing recognition device sends notification either through a wireless or hardwired network to output printing devices strategically located in the facility. These devices can be located at secretary desks, nursing stations, guard locations, etc. The final component of CENS consists of a card reader, capable of scanning driver licenses, insurance cards, personal information cards (such as medical history cards) and other media. This media will be stored in the CENS database located on a database server and can be printed out for client use, where copies of this material are need.

The output devices are simple printing devices similar to the printing devices that print off credit card receipts. The output information consists of the visitor's name, the time of arrival, and whom the person is visiting. Additional programming can be done to expand the software's capacity to report more data on the visitor. In addition, CENS can be programmed to interface with legacy software of multiple applications to pull out specific data to include in the print stream sent to the print device.

The Computerized Encounter Notification System (CENS), will increase productivity, reduce client dissatisfaction associated with waiting times, and improve system security by increasing the amount of information available to the organization, while maintaining an electronic database for visitors to any organization.

In summary, the Computerized Encounter Notification System (CENS) is an application requesting a patent for using existing technology in a new way to improve office efficiency, client satisfaction and office security. CENS will use existing hardware and software capable of recognizing individuals' handwriting to produce output streams of data to small printing devices. The output stream will include the name of the person signing the hand writing recognition input device (HRID) and other information as described earlier in this document.

In its totality, the system consist of 1) Handwriting recognition input device, 2) Printing Output Device, 3) Card scanner and printer, and 4) Application and Database servers. The software and hardware are readily available and can be modified to produce the output required for the CENS to produce the outcomes outlined in this patent application.

Steps in CENS Process

1. Visitor presents to the facility's registration area.
2. The facility's staff informs a visitor to use the handwriting recognition input device (HRID) to sign in.
3. Upon returning the stylus to the base, the HRID will send output to the POD (printing output device).
4. Patients who have cards containing insurance information, medical information, driver's license or other media such as credit cards, can insert their cards into the Card Scan Printer Device (CSPD). The CSPD will link the information to the visitor's information stored in the organization's automated patient database.
5. The output stream of data to the POD will show the visitor's name, time of sign in, reason for the visit (entered on the HRID through a free hand input function) or the CENS can be linked to an organization's automated appointment system to link the visitor's name to the appointment reason code listed in the organization's automated appointment system.
6. The PODs will be located at pre-determined locations throughout the facility. For instance, one location could be on a Chief Executive Officer's secretary's desk. Upon area to the facility and visitor would sign in, indicate the reason for the visit (i.e., here to see Mr. Ellerby in regards to Proposal 101). Upon returning the stylus to the HRID base, the output stream of data would transmit to the POD. The secretary would be notified electronically by the HRID that the visitor has arrived. In other settings such as medical facilities where patients are required to sign paper sign in list, the HRID could be pre-programmed to send data to the nurses' station, triage nurse, lab, medical records, physician and others who need to be notified of a patient's arrival. This will allow the medical office's staff to prepare for the needs of the patient in a more efficient manner.
7. The Application Server and the Database Server will host the application and database respectively. The database server will allow easy retrieval of encounter information should the need arise for an organization to validate a visitor's information. Once such validation would occur, if a patient complained of a lengthly waiting time from the time they signed in. The CENS will allow the end user to review electronic sign in time and compare it to information provided by the visitor. This will enhance organization's ability to improve quality of care and visitor satisfaction.

What is claimed is:

1. Computerized encounter notification system is a method for electronically obtaining handwriting signatures and other information on persons or visitors who are required to sign in as part of the notification process used by companies, organizations and other entities in order to notify the end user of the person, their arrival time.

2. Using existing technology and hardware currently in use in retail point of service environments including electronic signature pads, receipt output printer devices, card recognition devices and storage and server related hardware.

3. System can be hardwired or programmed to send output over a wireless network from the HRID units to the output devices.

4. Output will consist of visitor's name; sign in time, person who they are visiting, and the sign out time. Output will also include free text the user can determine to provide more information to the end user regarding the nature of the encounter.

5. All encounters will be electronically stored on the database server (DS) and can be retrieved as needed by the end user.
